(19) United States
(12) Patent Application Publication
(10) Pub. No.: US 2021/0362425 A1
(43) Pub. Date: Nov. 25, 2021

(54) REFERENCE OBJECT FOR THREE-DIMENSIONAL PRINTER

(71) Applicant: HEWLETT-PACKARD DEVELOPMENT COMPANY, L.P., Spring, TX (US)

(72) Inventors: Ingeborg TASTL, Palo Alto, CA (US); Alexandra Ling JU, Palo Alto, CA (US); Jordi ROCA, Sant Cugat del Valles (ES)

(73) Assignee: Hewlett-Packard Development Company, L.P., Spring, TX (US)

(21) Appl. No.: 17/040,560

(22) PCT Filed: Apr. 25, 2018
(86) PCT No.: PCT/US2018/029353

§ 371 Date: Sep. 23, 2020

(51) Int. Cl. B29C 64/386; B33Y 30/00; B33Y 50/00; B29C 64/176; G05B 19/4099

(52) U.S. Cl. CPC B29C 64/386; B33Y 30/00; B33Y 10/00; B29C 64/176; G05B 19/4099; B33Y 50/00

(57) ABSTRACT

A non-transitory medium having machine-readable instructions stored thereon is provided. The instructions include reference-object code to print a three-dimensional object in a coordinate system of a printer. The three-dimensional object includes a first loop portion comprising a length of a cylindrical body that extends arcuately between spaced apart ends thereof in through each axis of the coordinate system. A second loop portion comprising another length of the cylindrical body extends arcuately between spaced apart ends thereof through each axis of the coordinate system. The second loop portion is opposing and coupled with the first loop portion by respective curved leg portions of the cylindrical body to define a continuous loop that circumscribes a virtual axis thereof aligned with a layering direction of the printer. Each portion of the cylindrical body is asymmetrical with respect to each other.

### BACKGROUND

Three-dimensional (3D) printing refers to processes in which material is joined or solidified under computer control to create a three-dimensional object, with material being added in stages (e.g., such as liquid molecules or powder grains being fused together). Modern 3D printing is used in both rapid prototyping and additive manufacturing (AM). Printed objects can be of almost any shape or geometry and typically are produced using digital model data from a 3D model or another electronic data source such as an Additive Manufacturing File (AMF) file that can be produced in sequential layers. There are many different types of 3D printing technologies such as, for example, stereolithography (STL) or fused deposit modeling (FDM). Thus, unlike material removed from a stock in a conventional machining process, 3D printing builds a three-dimensional object from a computer-aided design (CAD) model or AMF file, usually by successively adding material layer by layer.

### BRIEF DESCRIPTION OF THE DRAWINGS

FIG. 1 illustrates an example of a non-transitory medium to store reference-object code to print a three-dimensional object.

FIG. 2 illustrates an example of a reference-object having one or more planar surfaces to facilitate measurements of the object.

FIG. 3 illustrates another view (from the bottom) of the example reference-object of FIG. 2 highlighting a reference marker.

FIG. 4 illustrates another example of reference-object of FIG. 2 including metadata printed on the 3D object.

FIG. 5 illustrates a printed object where reference-object code specifies multiple instances of reference objects that can be linked together.

FIG. 6 illustrates an example of a printed tag.

FIG. 7 illustrates a different view of the example printed tag of FIG. 6.

FIG. 8 illustrates a printed object where reference-object code specifies multiple instances of reference objects that can be linked together along with a printed tag.

FIG. 9 illustrates an example of a three-dimensional printer to store reference-object code to print a three-dimensional reference object.

FIG. 10 illustrates an example of a method to store reference-object code and to control printing of a three-dimensional reference object.

### DETAILED DESCRIPTION

A reference object described herein can be printed, from object reference code stored in memory (e.g., locally or remotely from a printer). The printed reference object has a size and configuration to visualize the capabilities and variability of a 3D printer. For example, the surface appearance (e.g., color) of the 3D reference object can vary with curved and one or more flat surfaces along surface normals extending from the object (e.g., the top of a cube might look different than the bottom and/or sides).

In one example, the reference object can act as a color reference where the user can determine how an arbitrary object can be designed based on how the color of the reference object appears when printed. The reference object also provides a representative sample for the appearance achievable with a specific printing system (e.g., combination of hardware, materials and printing conditions). Elements of the reference object can be constructed in a modular manner where elements can be removed or added to the object. In some examples, multiple modules can be connected and printed in a concurrent manner and later disassembled as desired. Users can readily change the color of individual elements by easily modifying it in the design prior to printing, for example, or by printing them in one color and then changing the appearance in a post-processing step. The reference-object code can be described in any number of 3D printing formats (e.g., 3MF format).

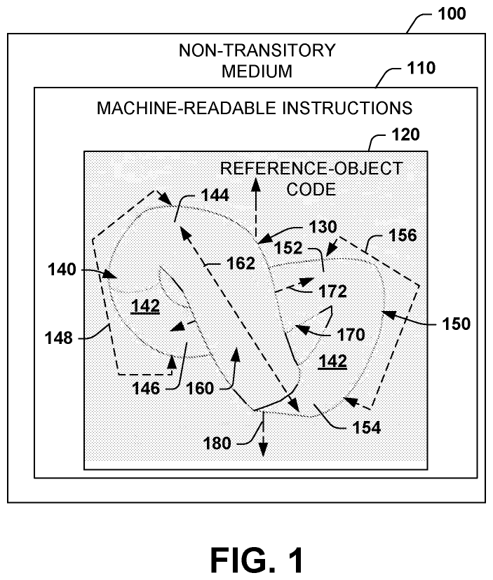

FIG. 1 illustrates an example of a non-transitory medium 100 to store reference-object code 120 to print a three-dimensional (3D) object 130. As used herein, the term non-transitory medium can include any type of computer memory including random access memory (RAM), read only memory (ROM), remote or virtual memory (e.g., via the Internet), and combinations thereof. As used herein, the term reference-object code refers to instructions that when combined, cause a three-dimensional printer to print the three-dimensional object 130 as disclosed herein. In one example, the reference-object code 120 may be stored in local memory of a printer. In another example, the reference-object code 120 is stored in remote storage device, such as in a server (e.g., at a predetermined network address), which can be accessed via a network connection (e.g., via wired and/or wireless communication link).

For example, the reference-object code 120 can be saved in a 3D-object format generated with a computer-aided design (CAD) software package. In one example, reference-object code 130 can be stored as a 3MF file. However, in other examples, it could be stored in other file formats. The 3D object format can specify geometry information as well as color information. Example 3D Modelling Software packages that can be employed to generate the reference-object code 130 include Materialise Magics (commercially available from Materialise NV), Netfabb (commercially available from Autodesk, Inc.), and 3D Builder (commercially available from Microsoft Corporation).

The non-transitory medium 100 includes machine-readable instructions stored thereon, which are executable by a processor. The instructions include the reference-object code 120 to print the three-dimensional object 130 in a coordinate system of a printer. For example, an individual layer of a 3D object can be built in the X-Y plane of a 3D Cartesian coordinate system of the printing bed. Individual layers of the 3D object are stacked on top of each other in the direction of the Z-axis of the printing bed. As disclosed herein, the three-dimensional object 130 includes a first loop portion, shown at reference 140. The loop portion 140 includes a length of a cylindrical body 142 that extends arcuately between spaced apart ends 144 and 146 thereof in through each axis of the coordinate system. The length of the cylindrical body 142 constituting the loop portion 140 is shown by dashed line 148. Another loop portion, shown at reference 150, includes another length of the cylindrical body that also extends arcuately between spaced apart ends 152 and 154 thereof through each axis of the coordinate system. The length of the cylindrical body 142 constituting the loop portion 150 is shown by dashed line 156.

The second loop portion 150 opposes and is coupled with the first loop portion 140 by respective curved leg portions 160 and 170 of the cylindrical body 142. The length of the cylindrical body 142 constituting each of the leg portions 160 and 170 is shown by respective dashed line 162 and 172. Thus, as shown, the leg portions 160 and 170 are connected between ends of the respective loop portions 140 and 150 to define a continuous contoured loop that circumscribes a virtual axis 180 extending through the object that is aligned with the direction of layers in a printing bed (e.g., the Z axis). In some examples, each portion 140, 150, 160 and 170 of the cylindrical body 142 is asymmetrical with respect to each other. In some examples, the cross-sectional diameter of the continuous loop of the reference-object 130 varies along different portions of the cylindrical body.

The reference-object code 120 can include instructions to print metadata on the three-dimensional object 130. For example, the metadata can be printed onto a flat surface of the cylindrical body 142. In one example, the instructions of the reference-object code are programmed to specify at least one of a plurality of printing parameters used in printing the three-dimensional object (e.g. specific print mode). The printing parameters may be set by default and/or be user programmable in response to a user input (e.g., entered at the printer or a computing device connected to the printer via a communications link).

The reference-object code 120 can also include instructions to specify one or more appearance attributes of the three-dimensional object. For example, the appearance attribute can include color, gloss, texture, or translucency. The reference-object code 120 can also include instructions to print a reference mark on a surface of cylindrical body having a predetermined position and orientation with respect to the coordinate system of the printing bed. In yet another example, the reference-object code 120 can include instructions to further print a tag which is attachable to and removable from the three-dimensional object 130, where the tag includes a surface that includes print metadata.

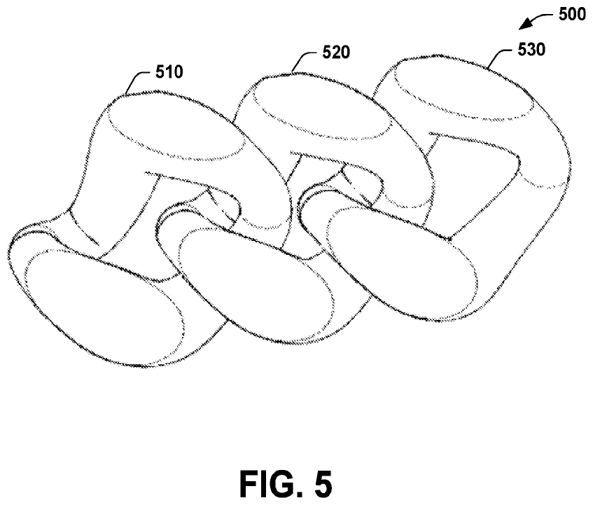

The reference object 130, when printed according to object code, provides a physical object that demonstrates the role of surface orientation (relative to the layer direction) on the appearance quality of 3D printed parts. It can be generated as a modular design (see e.g., FIG. 5) and provides a tool to easily and consistently compare the results of different user-selected parameters (e.g., color, print materials, printing mode, or post-processing method). The reference object 130 can operate as a color reference in which the user will know how an arbitrary object designed with a color of the reference object 130 will look like when printed, including colors on a variety of different surface orientations relative to layer direction.

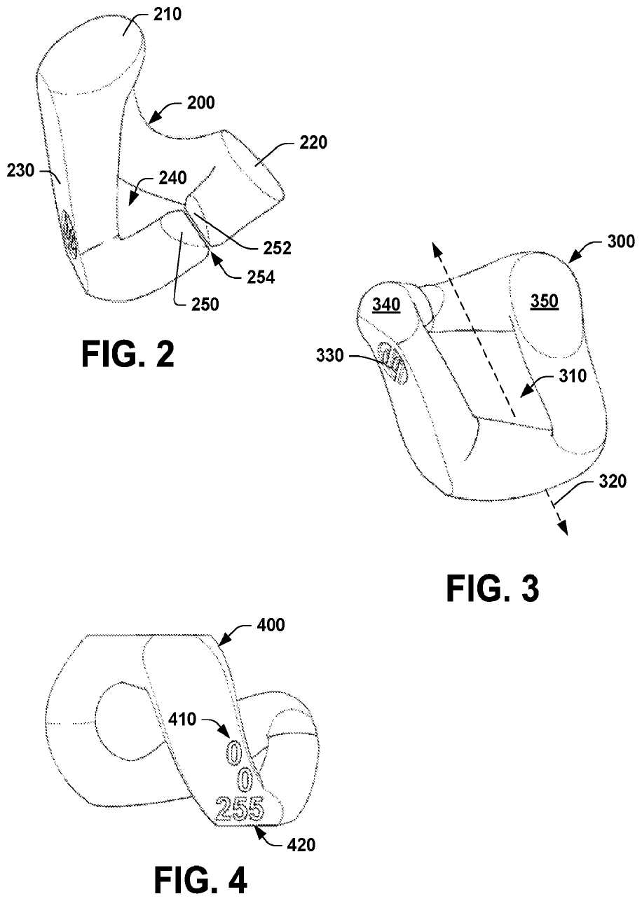

The reference-object code 120 can also include instructions to print one or more flat surfaces (see, e.g., FIG. 2) on the cylindrical body of the reference object 130. The flat portion may be provided along one or more of the loop or leg portions 140, 150, 160 or 170 or intersect two adjacent such portions. A given flat surface on a printed reference object demonstrates the appearance of the flat surface with respect to the layer direction 180. The flat surfaces in a printed reference object also can enable colorimetric measurements (e.g., via spectrophotometer or a colorimeter) along with providing visualizations of the gamut of achievable colors on a specific printing system. Physical color/texture examples along the varying surfaces of the reference object 120 in selectable colors are effective in communicating the achievable colors over the different surfaces. These selected colors can be provided as well to 3D print preview applications via a printer application programming interface (API) (not shown).

The reference object 130 also provides a physical representation for the appearance achievable with a specific printing system. It is scalable where elements of the reference object 130 can be removed or added and customizable where users can easily change the color of individual elements (e.g., via user interface that alters reference-object code 120 via a user input via an input interface of the 3D printer or a computing device in communication with the printer). Thus, the reference object 130 effectively shows appearance effects due to one or more flat and/or curved surfaces, for example. The appearance of a 3D printed object can also be modified during post-processing. The reference object can be utilized for both multi-color and monochromatic printing systems and suitable for both soft-proofing purposes (e.g., preview of the appearance of the printed object on the monitor) as well as for hard-copy proofs (the same material, the same color, but different object than the desired object). The reference object 130, when printed from object code, also may provide a simple and easy first-print experience for users.

In examples where the object code 120 of the reference object 130 is programmed to contain the color specifications on the object, the elements serve as true color references (e.g., such as a Pantone color chip). Thus, users can determine if they use a specific color (e.g., sRGB or other color space) then they will obtain a specific printed color as it will appear on the printed reference object. The color variations dependent on the surface normal of the reference object thus can easily and effectively be communicated via the printed reference object.

Beyond color, the reference objects 130 can be used to communicate the appearance of 3D printed object in a straightforward and effective manner (e.g., glossiness, roughness). The reference object 130 can also be used for diagnostic purposes (e.g., uniformity across the bed, uniformity over time, uniformity between different devices). For example, a print job can be defined where elements of the same color are placed at different positions (x, y, and z) in the printing bed and then when assembled can effectively visualize printer uniformity/non-uniformity. If the chosen colors are secondary colors (e.g., red, green and blue) then potential pen alignment issues can also be readily determined.

FIG. 2 illustrates an example of a reference-object 200 that includes one or more planar surfaces extending across radially outer extent of the curved cylindrical body. As mentioned, the planar surfaces can enable measurements of the object. The planar surfaces described herein can also be used to provide a stable base that can contact a flat support surface to hold the object at a desired portion, from which to view the printed three-dimensional objects described herein. It is desirable for the user to be able to see the object in the manner that it was printed (e.g., the flat surface of the 3D object that touches the support after printing was parallel to the x-y plane of the printing bed). In this example, the reference object 200 shows flat surfaces 210, 220, and 230 respectively. The plane surfaces on which the reference object 200 sits and that are not visible in FIG. 2 are illustrated in FIGS. 3 (340 and 350). In other examples, fewer or greater numbers of planar surfaces can be provided. The reference object 200 allows users to evaluate the surfaces and orientations in 3D printing. For example, users can observe the printed 3D reference object to understand the printer capabilities for various combinations of flat and contoured surfaces, which may be at predetermined angles with respect to the print direction.

The reference object 200 can also be designed to be measured using a contact color measurement device. As shown, the reference object 200 has flat surfaces 210, 220 and 230 extending predetermined orientations with respect to the layer direction (e.g., top, 45 and 90 degrees) and with sufficient surface area to enable measurement. Additionally, peripheral edges of each of the flat surfaces intersect with respective curved surfaces of the cylindrical body that extends between these flat areas. The printed reference object thus includes an arrangement of flat and curved surfaces along an asymmetric loop that provides a comprehensive sampling of angles on a single object in which surface appearances (e.g., color) can vary. Flat planes on the bottom (e.g., at 340, 350) of the reference object 200, which surfaces are perpendicular to the direction of layers, to allow the reference object to sit on a table as it is printed, providing clarity to the user assessing the part.

The reference object 200 can be printed both as a full assembly (e.g. several instances of reference object 200), or printed in shorter sections (e.g. the full assembly is printed in more than one section) or in form of individual elements and assembled into longer units afterwards (see e.g., FIGS. 5 and 8). The proportions of a central aperture 240 at about the centre of the object allow modular parts to print as an assembly with any number of 3D printing technologies. The cross-sectional diameter of the continuous loop of the cylindrical body of the reference object 200 can vary along different portions of the cylindrical body.

In some examples, the object code specifies that the continuous loop of the cylindrical body includes tapered ends 250 and 252 that abut each other at a meeting point 254 along the continuous loop. As used herein, the term “abut” may refer to contact or not contact spatial relationship between the ends 250 and 252. For example, the meeting point 254 may be at an intermediate portion of a curved leg portion of the cylindrical body (e.g., between loop portions). The tapering may be provided by planar surfaces that provide a 90-degree angle at the meeting point. The reference object may be printed from a pliant material to enable elastic deformation of the ends 250 and 252 with respect to each other to facilitate linking and unlinking together multiple objects, such as disclosed herein. Thus, the tapered ends 250 and 252 can provide a narrow, tapered opening in each part of an assembly to allow the parts to pull apart/come together and permitting post-assembly and/or disassembly. The size of the opening depends on the mechanical properties of the reference object defined by the printing system (e.g., hardware, material and printing parameters). In some examples, the reference-object code 120 can also include instructions to display the three-dimensional object 130 on a monitor (e.g., as a print preview—not shown) showing the appearance of the object when printed.

FIG. 3 illustrates a reference object 300 illustrating a different view of the example of reference-object of FIG. 2 (object is shown from the bottom). The flat surfaces (340, 350) are the surfaces on which the object 200 of FIG. 2 rests on when placed on a flat surface. In this example, an opening 310 defines a continuous loop that circumscribes a virtual axis 320 that is aligned with a layer direction of the printing bed. In this view, the object 300 also includes a reference marker 330 (also visible in FIG. 2) that is printed on one of its planar surfaces. The reference marker 330 provides a reference having a predetermined alignment with respect to the direction of printing (e.g., printed at the bottom of the back surface).

FIG. 4 illustrates yet another view of the reference object 400 different from the examples of FIGS. 2 and 3 (e.g., visualization from the back of the object). In this example, a customizable labeling area (or areas) is provided on a flat surface at 410. In this example, RGB information describing the color that was used when printing the object is provided. In other examples, other metadata information about the object being printed can be extracted from the reference object code and printed on the labeling area of such surface 410 (e.g., appearance attributes and/or parameters in the reference-object instructions and the printed object). In addition to supporting the customizable, scalable functionality of the reference object 400, by allowing parts to be labeled if/when desired, it also can act as an orientation reference point (e.g., like reference marker 330 in FIG. 3) to allow users to determine alignment between the 3D printed object with respect to the coordinate system of the printing bed. This may also be visualized on a monitor to show a preview of the reference object. Thus, together with flat planes such as shown at 420, they can indicate to the user the desired process to assemble parts.

FIG. 5 illustrates a printed object 500 where reference-object code specifies multiple object instances that can be linked together. In this example, example modular components 510, 520, and 530 can be printed concurrently and linked together as they are being printed. In some examples, the modular components 510, 520, and 530 can be printed separately and post-assembled by a robotic machine and/or user into the linked configuration. In other examples, the printed object 500 can be printed as a pre-assembled part that can be subsequently disassembled and/or reassembled. For example, each of the respective 3D reference objects includes tapered ends (e.g., ends 250 and 252) which can be used to connect and disconnect 3D objects, such as previously described. For example, the objects may have the same configuration (e.g., described by instances of the same code) but have different print color attributes, thereby demonstrating printer capabilities for different colors over the same set of surface shapes and contours. In other examples, more or less than three modular components 510, 520, and 530 can be employed to create the printed object 500.

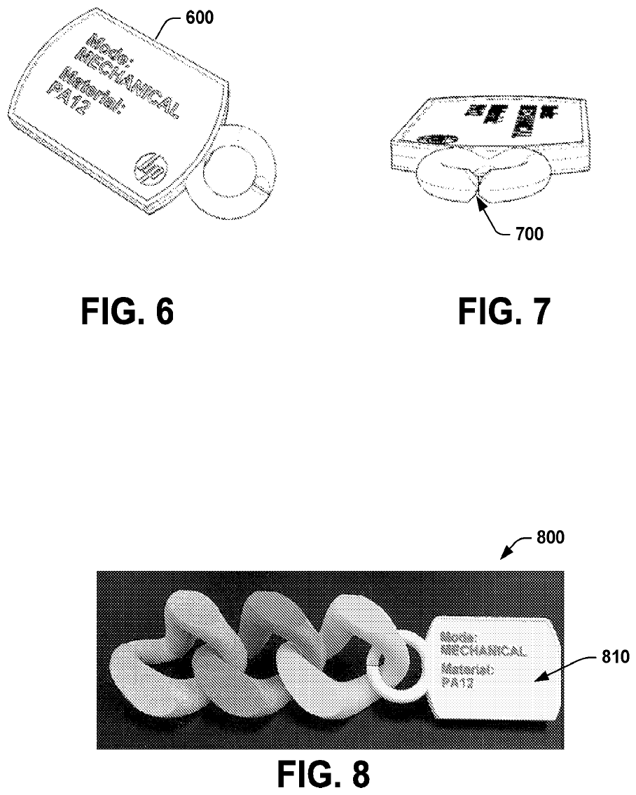

FIG. 6 illustrates an example of a printed tag 600 that can include metadata describing one or more print parameters and/or attributes of a printed reference object, such as manufacturing qualities of the reference object. The tag 600 may be defined in or be derived from the reference object code that is used to print a reference object. The metadata such as shown as Mode: Mechanical and Material: PA12 (e.g., powder type) in this example can include any data that indicates some quality regarding the construction of the reference objects described herein. Tags can be customized and labeled via an API (not shown) that modifies reference-object data. They can also be printed as part of an assembly, or printed individually and assembled later, by sharing the same tapered narrow opening as the appearance reference objects such as shown at 700 of FIG. 7 that illustrates a different view of the example printed tag of FIG. 6. FIG. 8 illustrates a printed object 800, according to reference-object code that specifies multiple instances of reference objects (e.g., 130, 200, 300, 400) linked together along and including a printed tag 810 (e.g., tag 600, 700).

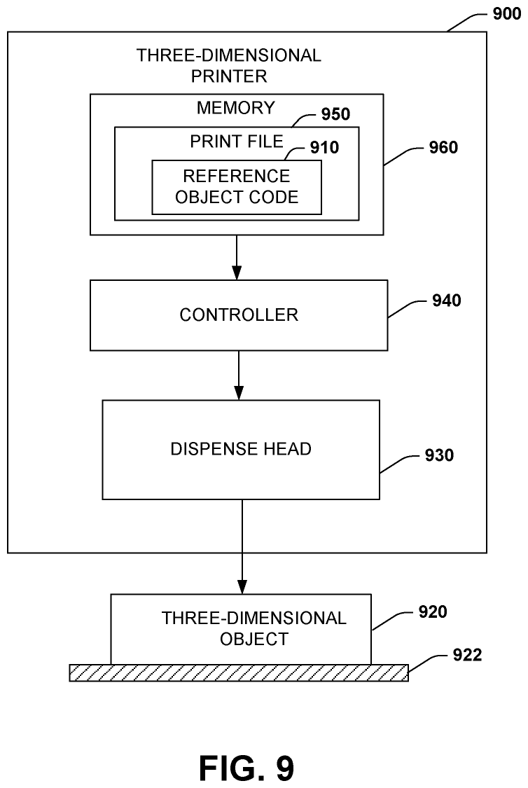

FIG. 9 illustrates an example of a three-dimensional printer 900 to store reference-object code (e.g., code 120) 910 to print a three-dimensional object (e.g., object 130, 200, 300, 400) 920. As shown, the three-dimensional printer 900 includes a dispense head 930 (or heads) to dispense materials to print the three-dimensional object 920 in a coordinate system (e.g., X, Y, Z coordinate system aligned with the layering and printing direction of the printer), such as residing on a print platform 922. A controller 940 (e.g., microprocessor) 940 controls the dispense head 930 in response to print instructions that are stored in a print file 950. A memory 960 stores the print file 950 that includes the reference-object code 910 to print the three-dimensional object 920.

By way of example, as mentioned with respect to FIG. 1, the reference-object code 910 includes a first loop portion comprising a length of a cylindrical body that extends arcuately between spaced apart ends thereof in through each axis of the coordinate system. A second loop portion comprises another length of the cylindrical body that extends arcuately between spaced apart ends thereof through each axis of the coordinate system.

The second loop portion is opposing and coupled with the first loop portion by respective curved leg portions of the cylindrical body to define a continuous loop that circumscribes a virtual axis aligned with a print direction of the printer 900, with each portion of the cylindrical body being asymmetrical with respect to each other. As noted previously, the three-dimensional object 920 can include a planar surface (or surfaces on the cylindrical body to provide a location where measurements can be taken (e.g., color measurements). The planar surfaces can also be used to provide a stable resting position for the three-dimensional object 920. In some examples, the continuous loop of the cylindrical body can include ends that abut each other at a meeting point along the continuous loop, which ends may be tapered to facilitate linking and unlinking loops with respect to each other.

In one example, the three-dimensional object 920 is a given three-dimensional object, where the reference-object code 910 includes code programmed to further multiple instances of the three-dimensional object concurrently with the given three-dimensional object such that the continuous loops are linked together, where the meeting points along the cylindrical body facilitate connection and removal of the loops with respect to each other (see, e.g., FIG. 5). The reference-object code 910 can also include instructions to specify an appearance attribute that is printed on the three-dimensional object (e.g., color, texture, gloss, and so forth). The reference-object code 910 can also include instructions to specify a reference mark printed on a surface of cylindrical body having a predetermined position and orientation with respect to the coordinate system in order to allow a user to synchronize the display of the three-dimensional object 920 with the manner in which the object was printed.

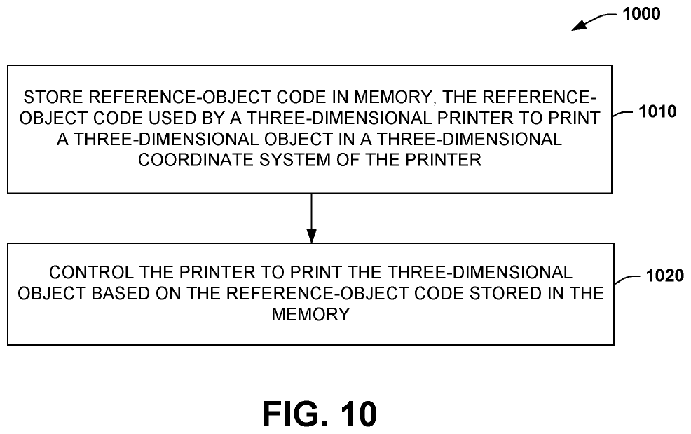

In view of the foregoing structural and functional features described above, an example method will be better appreciated with reference to FIG. 10. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by various components configured as machine-readable instructions stored in memory and executable in an integrated circuit or a processor, for example.

FIG. 10 illustrates an example of a method 1000 to store reference-object code and to control printing of a three-dimensional object based on the reference object code. At 1010, the method 1000 includes storing reference-object code in memory (e.g., via non-transitory medium 100 and machine-readable instructions 110 of FIG. 1). A three-dimensional printer employs the reference-object code to print a three-dimensional object in a three-dimensional coordinate system of the printer. The code may be stored in memory that is local or remote with respect to the printer. The three-dimensional object a first loop portion comprising a length of a cylindrical body that extends arcuately between spaced apart ends thereof in through each axis of the coordinate system. The three-dimensional object includes a second loop portion comprising another length of the cylindrical body that extends arcuately between spaced apart ends thereof through each axis of the coordinate system. The second loop portion is opposing and coupled with the first loop portion by respective curved leg portions of the cylindrical body to define a continuous loop that circumscribes an axis aligned with a print direction of the printer. Each portion of the cylindrical body is asymmetrical with respect to each other. At 1020, the method 1000 includes controlling the printer to print the three-dimensional object based on the reference-object code stored in the memory (e.g., via controller 940 of FIG. 9). In one example, the three-dimensional object is a given three-dimensional object, where the method 1000 further includes controlling the printer to print another instance of the three-dimensional object concurrently with the given three-dimensional object in the coordinate system, such that the continuous loops are linked together.

What has been described above are examples. One of ordinary skill in the art will recognize that many further combinations and permutations are possible. Accordingly, this disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A non-transitory medium having machine-readable instructions stored thereon, the instructions comprising:
reference-object code to print a three-dimensional object in a coordinate system of a printer, the three-dimensional object comprising:
a first loop portion comprising a length of a cylindrical body that extends arcuately between spaced apart ends thereof in through each axis of the coordinate system;
a second loop portion comprising another length of the cylindrical body that extends arcuately between spaced apart ends thereof through each axis of the coordinate system, the second loop portion opposing and coupled with the first loop portion by respective curved leg portions of the cylindrical body to define a continuous loop that circumscribes a virtual axis thereof aligned with a layering direction of the printer,
each portion of the cylindrical body being asymmetrical with respect to each other.

2. The medium of claim 1, wherein the three-dimensional object further comprises a planar surface on the cylindrical body.

3. The medium of claim 1, wherein the reference-object code is to print metadata on the three-dimensional object to specify at least one of a plurality of printing parameters used in printing the three-dimensional object.

4. The medium of claim 1, wherein the cross-sectional diameter of the continuous loop varies along different portions of the cylindrical body and the continuous loop of the cylindrical body includes tapered ends that abut each other at a meeting point along the continuous loop.

5. The medium of claim 4, wherein the three-dimensional object is a given three-dimensional object, the reference-object code to further print another instance of the three-dimensional object, corresponding to another continuous loop, concurrently with the given three-dimensional object such that the continuous loops are linked together in an asymmetrical manner to facilitate a consistent orientation of the linked objects and the meeting points facilitate connection and removal of the given continuous loop with respect to the other continuous loop.

6. The medium of claim 1, wherein the reference-object code further includes instructions to display the three-dimensional object on a monitor showing the appearance of the object when printed.

7. The medium of claim 1, wherein the reference-object code further includes instructions to specify an appearance attribute of the three-dimensional object, the appearance attribute includes color, gloss, texture or translucency.

8. The medium of claim 1, wherein the reference-object code includes instructions to specify a reference mark on a surface of cylindrical body having a predetermined position and orientation with respect to the coordinate system of the printing bed.

9. The medium of claim 1, wherein the reference-object code to further print a tag, which is attachable to and removable from the three-dimensional object, the tag including a surface that includes print metadata.

10. A three-dimensional printer, comprising:
a dispense head to dispense materials to print a three-dimensional object in a coordinate system;
a controller to control the dispense head in response to print instructions that are stored in a print file; and
memory to store the print file, the print file including reference-object code to print the three-dimensional object, comprising:
a first loop portion comprising a length of a cylindrical body that extends arcuately between spaced apart ends thereof in through each axis of the coordinate system;
a second loop portion comprising another length of the cylindrical body that extends arcuately between spaced apart ends thereof through each axis of the coordinate system, the second loop portion opposing and coupled with the first loop portion by respective curved leg portions of the cylindrical body to define a continuous loop that circumscribes a virtual axis aligned with a print direction of the printer,
each portion of the cylindrical body being asymmetrical with respect to each other.

11. The printer of claim 10, wherein the three-dimensional object further comprises a planar surface on the cylindrical body.

12. The printer of claim 10, wherein the continuous loop of the cylindrical body includes ends that abut each other at a meeting point along the continuous loop,
wherein the three-dimensional object is a given three-dimensional object, the reference-object code to further print another instance of the three-dimensional object, corresponding to another continuous loop, concurrently with the given three-dimensional object such that given continuous loop is linked together with the other continuous loop and the meeting points thereof facilitate connection and removal of the continuous loops with respect to each other.

13. The printer of claim 12, wherein the reference-object code includes instructions to specify an appearance attribute that is printed on the three-dimensional object, and
wherein the reference-object code includes instructions to specify a reference mark printed on a surface of cylindrical body having a predetermined position and orientation with respect to the coordinate system of the printing bed.

14. A method, comprising:
storing reference-object code in memory, the reference-object code used by a three-dimensional printer to print a three-dimensional object in a three-dimensional coordinate system of the printer, the three-dimensional object comprising:
a first loop portion comprising a length of a cylindrical body that extends arcuately between spaced apart ends thereof in through each axis of the coordinate system;
a second loop portion comprising another length of the cylindrical body that extends arcuately between spaced apart ends thereof through each axis of the coordinate system, the second loop portion opposing and coupled with the first loop portion by respective curved leg portions of the cylindrical body to define a continuous loop that circumscribes an axis aligned with a print direction of the printer,
each portion of the cylindrical body being asymmetrical with respect to each other; and
controlling the printer to print the three-dimensional object based on the reference-object code stored in the memory.

15. The method of claim 14, wherein the three-dimensional object is a given three-dimensional object, the method further comprising controlling the printer to print another instance of the three-dimensional object, corresponding to another continuous loop, concurrently with the given three-dimensional object in the coordinate system, such that the continuous loops are linked together.
